(19) United States
(12) Patent Application Publication
(10) Pub. No.: US 2003/0064853 A1
(43) Pub. Date: Apr. 3, 2003

(54) Belleville spring-loaded taper roller bearing support system for a hydrodynamic retarder

(76) Inventors: Conrad L. Rockey, Indianapolis, IN (US); Steven Franklin James, Zionsville, IN (US); Mark A. Rader, Danville, IN (US)

Correspondence Address: LESLIE C. HODGES, General Motors Corporation, Legal Staff, Mail Code 482-C23-B21, P.O. Box 300, Detroit, MI, 48265-3000, US

(21) Appl. No.: 09/968,827

(22) Filed: Oct. 3, 2001

(51) Int. Cl. F16H 57/08

(52) U.S. Cl. 475/331

(57) ABSTRACT

A hydrodynamic retarder has an outer housing and an inner housing. A planetary carrier shaft member is rotatably supported on taper roller bearings located in the outer housing. The taper roller bearings are positioned between a shoulder on the shaft and a retaining nut or fastener which is threadably secured to the shaft. A Belleville or Belleville spring is positioned between the retaining nut and the inner race of one of the roller bearings. The retaining nut is secured such that the Belleville spring is flattened thereby applying maximum force to the inner race. The force is transmitted through the first roller bearing, the outer housing, the outer race of a second roller bearing, the second rollers and the second inner race. The Belleville spring will accommodate axial movement between the retaining nut and the bearing. The axial movement might be occasioned by internal forces of the hydrodynamic retarder or external forces that are initiated by a hydraulic piston associated with the hydrodynamic retarder. The retaining nut force might also be reduced due to the expanding and contraction of internal components, such as gaskets, seals and seating surfaces. The Belleville spring accommodates these movements and retains a substantially constant axial seating force for the taper roller bearings and a substantially constant normal force on the retaining nut.

### TECHNICAL FIELD

This invention relates to roller bearing support systems and, more particularly, to roller bearing support systems in hydrodynamic retarders in a transmission structure.

### BACKGROUND OF THE INVENTION

Hydrodynamic retarders have been used with power transmissions for a number of years. These devices are utilized to improve the braking or stopping operation of large trucks and reduce the wear of the service brakes during the braking operation. The hydrodynamic retarder has generally been disposed within the power transmission either on the input side of the transmission or on the output side.

When disposed on the output side, the hydrodynamic retarder is positioned on a pair of taper roller bearings which are spaced along the output shaft of the transmission and secured in position by a locking nut and a retaining washer. The washer is disposed between the locking nut and one of the roller bearings.

In many transmissions, the hydrodynamic retarder has an outer housing and a rotor. The outer housing is utilized as a bore for a piston member of a stationary torque transmitting mechanism (brake) which is activated to establish one or more gear ratios within the transmission. The hydrodynamic retarder is subjected to many interior forces such as a pressure buildup during retardation and external forces such as operation of the brake. The retaining nut position relative to the taper roller bearing is also subject to change due to housing deflections, gasket compression, and other elements disposed within the retarder or within the transmission as well as thermal expansion and contraction.

The prior art transmissions have encountered several issues due to the change of preload which can occur on the taper roller bearing due to the many forces imposed thereon and the movement of internal components.

### SUMMARY OF THE INVENTION

It is an object of the present invention to provide an improved hydrodynamic retarder support system incorporating a pair of spaced roller bearings that are preloaded to a predetermined position by a Belleville spring which is positioned adjacent the taper roller bearing by a retaining nut.

In one aspect of the invention, the taper roller bearings are secured between a shoulder on a carrier supporting the retarder and the Belleville spring which is positioned by a retaining nut. In another aspect to the present invention, the Belleville spring is compressed to a substantially flat condition to apply maximum normal force to the retaining nut and positioning force to the taper roller bearings.

It is another aspect of the present invention to provide a constant force between the taper roller bearing and the retaining nut that can compensate for the factors that normally tend to reduce the bearing pre-load.

In another aspect of the present invention, the Belleville spring applies a normal force to the retaining nut to increase the frictional forces between the retaining nut thread and the shaft thread on which the retaining nut is secured.

In a further aspect of the present invention, the Belleville spring permits a limited amount of travel or separation between the retaining nut and the taper roller bearing while maintaining a constant load on both the bearings and the retaining nut.

### BRIEF DESCRIPTION OF THE DRAWINGS

FIG. 1 is a cross-sectional elevational view of a portion of a transmission and hydrodynamic retarder incorporating the present invention.

FIG. 2 is a view of a portion of FIG. 1 describing the installation of a Belleville spring on a transmission carrier.

FIG. 3 is a curve showing the load versus deflection of a Belleville spring used in the present invention.

### DESCRIPTION OF THE PREFERRED EMBODIMENT

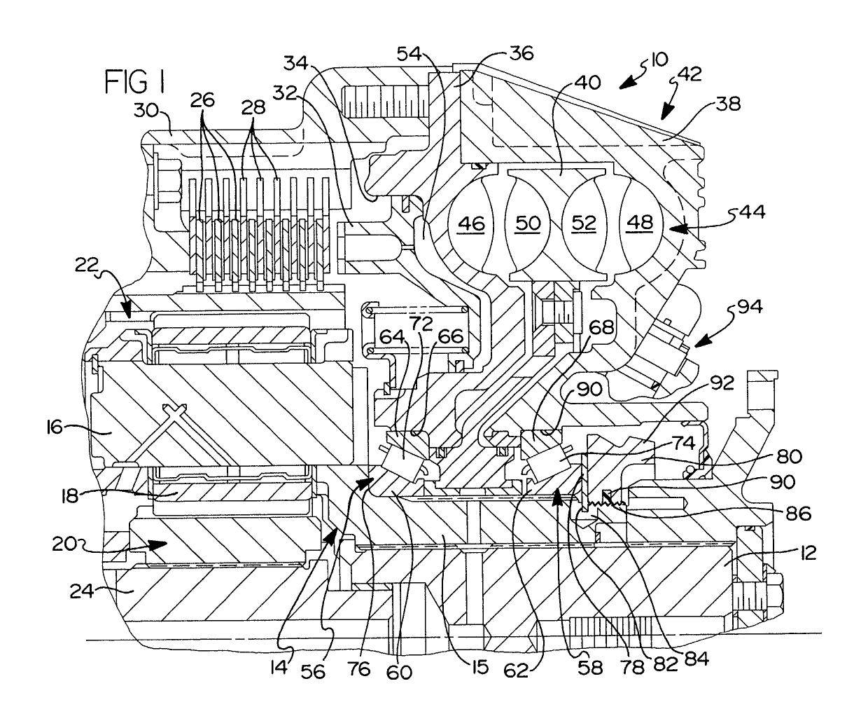

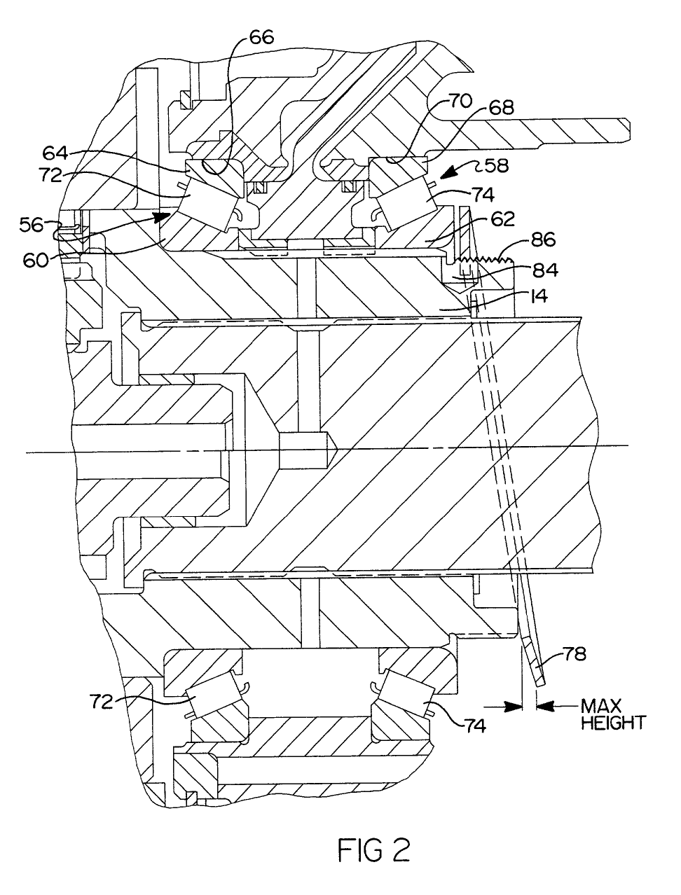

A portion of a transmission 10, shown in FIGS. 1 and 2, includes a transmission output shaft 12 that has a planet carrier member 14 with a shaft extension 15 splined thereto. The carrier member 14 supports a plurality of spindles 16 on which are rotatably disposed planet pinion gears 18. The pinion gears 18 are disposed in meshing relationship with a sun gear member 20 and a ring gear member 22. The combination of the planet carrier member 14, sun gear member 20 and ring gear member 22 comprise rotatable members of a conventional planetary gear assembly. The sun gear member 20 is splined to a transmission shaft 24, and the ring gear member 22 is splined to a plurality of friction plate members 26. The friction plate members 26 are interspersed with a plurality of reaction plate members 28 that are splined to a portion of a transmission housing 30.

The plate members 26 and 28 cooperate with a fluid-operated piston 32 to form a friction brake which is operable to retard or restrain rotation of the ring gear 22. The piston 32 is slidably supported in a chamber or cavity 34 formed in an outer housing 36 which is secured with the transmission housing 30. The outer housing 36 cooperates with another outer housing 38 to form an outer chamber for a retarder rotor 40 which is rotatably secured with the carrier 14 and therefore the output shaft 12.

The housings 36 and 38 form a retarder housing 42 for a hydrodynamic retarder 44. The rotor 40 is a member of the hydrodynamic retarder 44. The outer housings 36 and 38 include a plurality of blades or vane members 46 and 48, respectively, and the rotor 40 has a plurality of blade or vane members 50 and 52 which are diametrically opposed to the blades members 46 and 48, respectively.

The chamber 34 cooperates with the piston 32 to form a hydraulic chamber 54 which is subjected to fluid pressure through a passage, not shown, when it is desired to apply the plate members 26 and 28 to thereby prevent rotation of the ring gear 22. The force generated by the fluid pressure within the chamber 54 is reacted on the housing 36 as well as the piston 32.

The carrier 14 is supported on taper roller bearing 56 and 58. The taper roller bearing 56 includes an inner race 60 that is press-fit on the carrier 14 and the taper roller bearing 58 includes an inner race 62 that is press-fit on the carrier 14. The taper roller bearing 56 has an outer race 64 that is press-fit into a bore 66 on the housing 36 and the taper roller bearing 58 has an outer race 68 that is press-fit in a bore 70 formed thereon.

The inner races 60 and 62 are separated from the respective outer races 64 and 68 by a plurality of rollers 72 and 74, respectively. This is the construction of well-known tapered roller bearings. As is well known with tapered roller bearings, the bearing will support both radial and axial forces which are imposed by external loads. The inner race 60 of the taper roller bearing 56 is secured in abutment with a shoulder 76 formed on the carrier 14. The inner race 62 of the taper roller bearing 58 is positioned along the carrier 14 by a Belleville spring 78 and a retaining fastener such as retaining nut 80.

As seen in FIG. 2, the Belleville spring 78 has an inwardly extending tab or tang 82 that is positioned in a radial hole 84 formed in the carrier 14. When the tab 82 is positioned in the hole 84, the Belleville spring 78 can be tilted or rotated into position on the carrier 14 and then the retaining nut 80 can be applied to a threaded portion 86 formed on the carrier 14. The retaining nut 80 is threaded on the carrier 14 and moves axially thereon to compress the Belleville spring 78.

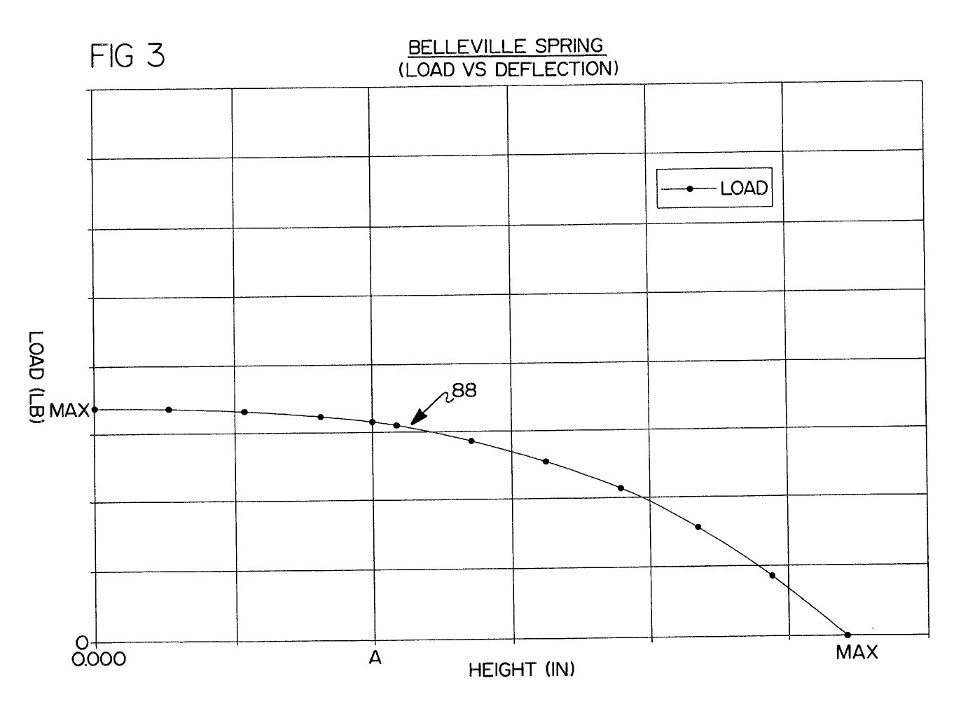

As seen in FIG. 3, the Belleville spring reaction force represented by curve 88 increases when the height of the Belleville spring 78 is reduced from a maximum value to a minimum value. The reaction force 88 of the spring 78 is substantially constant between a height A and a zero height or flattened position of the spring 78.

The reaction or loading force of the Belleville spring 78 is transmitted through the taper roller bearing 58, the housing 42 and the taper roller bearing 56 to the shoulder 76 of the carrier 14. This does two things: it positions the hydrodynamic retarder rotor 44 on the carrier 14 and preloads the taper roller bearings 58 and 56 to the desired load level.

Another advantage of the Belleville spring 78 is that a reaction force is applied to the retaining nut 80. The retaining nut 80 being a threaded fastener is frictionally engaged between the threads on the carrier 14 and the nut 80. It is also desirable to incorporate a plurality of polymeric inserts 90 in the nut 80 to fully improve the frictional engagement. However, the main retaining force or positioning force for the nut 80 is the frictional force which is a result of the normal force applied by the reaction load 88 of the Belleville spring 78. This holds the nut 80 in the desired location and prevents the reduction of the preload on the spring 78.

One of the reasons it is desirable to retain the nut 80 in the desired location is that the outer surface 92 of the nut 80 is castellated to provide a plurality of spaced risers which are viewed by a sensor 94 to determine the rotary speed of the carrier 14 and therefore the output shaft 12. If the retaining nut 80 were to become loosened, the speed reading generated at the sensor 94 would become erratic and therefore confuse the transmission control system during the operation of the vehicle in which the transmission is employed.

The tapered roller bearings and therefore the Belleville spring 78 are subjected to a plurality of forces. One of the forces generated is the hydraulic force internally of the hydrodynamic retarder 44 when the space between the outer housings 36 and 38 and the inner housings 40 is pressurized during vehicle retardation. This force tends to urge separation of the bearings 56 and 58. Another external force that is generated is the force generated by the pressure in the cavity 54 when the piston 32 is pressurized to engage the plate members 26 and 28. This force urges the housing 36 to move rearward in the transmission thereby tending to reduce the load on the bearing 56. The preloading of the bearings compensates for this force as well as the internal force generated within the hydrodynamic retarder 42. Thus, the pre-load force on the bearings 56 and 58 and the reaction force on the retaining nut 80 are maintained at a substantially constant value.

1. A bearing retention and positioning system for a power transmission having a hydrodynamic retarder comprising:
a first bearing having an inner race seated against and rotatable with a rotatable transmission element and an outer race seated against a first portion of a stationary housing of the hydrodynamic retarder;
a second bearing axially spaced from said first bearing and including an inner race disposed on and rotatable with said rotatable transmission element, and an outer race seated against a second portion of said stationary housing of the retarder;
a Belleville spring disposed on said rotatable transmission element and having a tab portion engaged in an opening in said transmission element; and
a retaining fastener threadably positioned on said transmission element and being threadably engaged therewith to urge said Belleville spring into abutment with said outer race of said second bearing applying a force thereto to cause said second bearing, said stationary housing, and said first bearing to be axially positioned on said transmission element with a predetermined force and said Belleville spring accommodating a limited axial movement on said transmission element while maintaining said force substantially constant.

2. The bearing retention system for a power transmission defined in claim 1, wherein said rotatable transmission element consists of a planetary gear set member connected with a transmission output member.

3. The bearing retention system for a power transmission defined in claim 1, wherein said tab portion of said Belleville spring extends radially inward and said opening in said transmission element consists of a radially extending cavity.

4. The bearing retention system for a power transmission defined in claim 3, wherein said transmission element comprises a planetary carrier member having an axially extending shaft portion on which said bearings and said retarder housing are supported.
